(19) United States
(12) Patent Application Publication
(10) Pub. No.: US 2024/0296817 A1
(43) Pub. Date: Sep. 5, 2024

(54) ELECTRONIC DEVICE AND OPERATION METHOD THEREOF

(71) Applicant: Samsung Electronics Co., Ltd., Suwon-si (KR)

(72) Inventors: Doyun KIM, Suwon-si (KR); Eunae CHO, Suwon-si (KR); Sangshin PARK, Suwon-si (KR)

(73) Assignee: Samsung Electronics Co., Ltd., Suwon-si (KR)

(21) Appl. No.: 18/657,439

(22) Filed: May 7, 2024

Related U.S. Application Data
(63) Continuation of application No. PCT/KR2022/013989, filed on Sep. 19, 2022.

(30) Foreign Application Priority Data
Nov. 26, 2021 (KR) 10-2021-0166096

(51) Int. Cl. G10H 1/00; G10L 21/028; G10L 25/63

(52) U.S. Cl. CPC G10H 1/0025; G10L 21/028; G10L 25/63; G10H 2210/066; G10H 2210/076; G10H 2210/111; G10H 2210/325; G10H 2210/391; G10H 2220/441; G10H 2250/311

(57) ABSTRACT

An operation method of an electronic device including obtaining multi-mood information from at least one of user situation information and screen situation information, obtaining metadata from at least one of user preference information, the multi-mood information, and external situation information, and obtaining the sheet music for music performance from the metadata by using at least one neural network.

### CROSS-REFERENCE TO RELATED APPLICATION

This application is a continuation application, under 35 U.S.C. § 111 (a), of international application No. PCT/KR2022/013989, filed on Sep. 19, 2022, which claims priority under 35 U. S. C. § 119 to Korean Patent Application No. 10-2021-0166096, filed on Nov. 26, 2021, in the Korean Intellectual Property Office, the disclosures of which are incorporated by reference herein in their entireties.

### TECHNICAL FIELD

Various disclosed embodiments relate to an electronic device and an operation method thereof, and more specifically, to an electronic device for automatically generating music based on a situation, a user's preference, or the like, and an operation method of the electronic device.

### BACKGROUND ART

Because composing music is a specialized field, it is difficult to create music without professional knowledge. There is an issue in that it is cumbersome that a user may only listen to music by selecting or inputting a desired style of music from a given category. In addition, there is another issue in that a music generation device is able to generate or retrieve and reproduce music that matches a condition input by a user, but is unable to reflect various user situations that change over time.

Thus, there is a need for a technique for automatically considering a surrounding environment, a user's preference, an image displayed on a display device, and the like, to generate music that matches the user's situation and preference, and providing the music to the user.

### DISCLOSURE

### Technical Solution

An electronic device according to an embodiment may include a memory to store one or more instructions, and a processor configured to execute the one or more instructions that are stored in the memory, to: obtain situation information, for music performance, including at least one of user situation information associated with a user, screen situation information associated with a screen, and external situation information associated with at least one of the user and the electronic device, obtain user preference information based on a previous music listening history of the user, and obtain sheet music with representation useable for the music performance from at least one of the situation information for music performance and the user preference information, by using at least one neural network.

### DESCRIPTION OF DRAWINGS

FIG. 1 is a diagram illustrating generating music and providing it to a user in consideration of the user's preference and situation, according to an embodiment.

FIG. 2 is an internal block diagram of an electronic device according to an embodiment.

FIG. 3 is an internal block diagram of a processor included in an electronic device according to an embodiment.

FIG. 4 is an internal block diagram of a situation information obtaining unit included in an electronic device, according to an embodiment.

FIG. 5 is a diagram for describing a method, performed by a user situation information obtaining unit, of obtaining user situation information, according to an embodiment.

FIG. 6 is a diagram illustrating a method, performed by a screen situation information obtaining unit, of obtaining screen situation information, according to an embodiment.

FIG. 7 is a diagram for describing obtaining, by an electronic device, sheet music for music performance from at least one of situation information and user preference information, according to an embodiment.

FIG. 8 is a diagram for describing an operation of a first neural network according to an embodiment.

FIG. 9 is a diagram for describing an operation of a second neural network according to an embodiment.

FIG. 10 is a diagram for describing an operation of a third neural network according to an embodiment.

FIG. 11 is an internal block diagram of an electronic device according to an embodiment of the disclosure.

FIG. 12 is a flowchart of a process, performed by which an electronic device, of obtaining sheet music, according to an embodiment.

FIG. 13 is a flowchart of a process, performed by an electronic device, of obtaining sheet music by using at least one neural network, according to an embodiment.

FIG. 14 is a diagram illustrating various situations in which an electronic device operates, according to an embodiment.

### MODE FOR INVENTION

In an embodiment, the processor may execute the one or more instructions to obtain multi-mood information from at least one of the user situation information and the screen situation information, by using a first neural network, obtain metadata from at least one of the user preference information, the multi-mood information, and the external situation information, by using a second neural network, and obtain the sheet music for music performance from the metadata by using a third neural network.

In an embodiment, the first neural network may include a softmax regression function, and the first neural network may be a neural network trained to have a weight that minimizes a difference between a ground-truth set and a weighted sum of a weight and a at least one variable of the user situation information and the screen situation information.

In an embodiment, the second neural network may include an encoder of a transformer model and an output layer, the metadata may include first metadata and second metadata, the processor may execute the one or more instructions to embed at least one of the user preference information, the multi-mood information, and the external situation information, input a result of the embedding into the encoder of the transformer model, obtain the first metadata by applying a softmax function as an output layer, to a weight that is output from the encoder of the transformer model, and obtain the second metadata by applying a fully connected layer as the output layer, to the weight that is output from the encoder of the transformer model, the first metadata may include at least one of a tempo, a velocity, an instrument, and an ambient sound, and the second metadata may include at least one of a pitch and a music performance length.

In an embodiment, the third neural network may include a transformer-XL model, and the processor may execute the one or more instructions to obtain a first probability distribution of an event sequence by embedding the metadata, and inputting a result of the embedding into the transformer-XL model, and obtain a first bar by sampling the first probability distribution of the event sequence.

In an embodiment, the processor may execute the one or more instructions to obtain a second probability distribution of an event sequence from the transformer-XL model by feeding forward the first bar to the transformer-XL model, and obtain a second bar subsequent to the first bar by sampling the second probability distribution of the event sequence.

In an embodiment, the first probability distribution of the event sequence may include a probability distribution for each of a tempo, a velocity, and a pitch.

In an embodiment, the device may further include a user preference information database, and the processor may execute the one or more instructions to obtain, from the user preference information database, user preference information obtained based on information about music that the user has previously listened to, reproduce music according to the sheet music for music performance, and update the user preference information database by adding information related to the reproducing of the music, to the user preference information database.

In an embodiment, the user preference information may include at least one of identification information of the user, mood information, velocity information, ambient sound information, and instrument information of the music that the user has previously listened to, information about a frequency of reproduction of the music, information about a time during which the music has been reproduced, information about a screen situation when the music is reproduced, and information about an external situation when the music is reproduced.

In an embodiment, the user situation information may include at least one of user identification information, activity information, and emotion information, and the processor may execute the one or more instructions to separate a voice and noise from an audio signal, and obtain the user situation information from at least one of the voice and the noise by performing at least one of identifying the user based on the voice, obtaining emotion information of the user based on the voice of the identified user, and obtaining information about an activity performed by the user, based on at least one of the voice and the noise.

In an embodiment, the device may further include a display, and the processor may execute the one or more instructions to obtain the screen situation information based on at least one of style information and color information of an image that is output on the display.

In an embodiment, the device may further include at least one of a sensor and a communication module, and the processor may execute the one or more instructions to obtain the external situation information from at least one of weather information, date information, time information, season information, illuminance information, and location information that are obtained from at least one of the sensor and the communication module.

An operation method of an electronic device according to an embodiment may include obtaining situation information for music performance including at least one of user situation information, screen situation information, and external situation information, obtaining user preference information based on a previous listening history of a user, and obtaining sheet music for music performance from at least one of the situation information for music performance and the user preference information, by using at least one neural network.

A computer-readable recording medium according to an embodiment may be a computer-readable recording medium having recorded thereon a program for implementing an operation method of an electronic device, the operation method including obtaining situation information for music performance including at least one of user situation information, screen situation information, and external situation information, obtaining user preference information based on a previous listening history of a user, and obtaining sheet music for music performance from at least one of the situation information for music performance and the user preference information, by using at least one neural network.

Hereinafter, embodiments of the present disclosure will be described in detail with reference to the accompanying drawings to enable those of skill in the art to perform the present disclosure without any difficulty. The present disclosure may, however, be embodied in many different forms and should not be construed as being limited to an embodiment set forth herein.

Although the terms used herein are generic terms, which are currently widely used and are selected by taking into consideration functions thereof, the meanings of the terms may vary according to intentions of those of ordinary skill in the art, legal precedents, or the advent of new technology. Thus, the terms should be defined not by simple appellations thereof but based on the meanings thereof and the context of descriptions throughout the present disclosure.

In addition, terms used herein are for describing a particular embodiment, and are not intended to limit the scope of the present disclosure.

Throughout the specification, when a part is referred to as being “connected to” another part, it may be “directly connected to” the other part or be “electrically connected to” the other part through an intervening element.

The term “the” and other demonstratives similar thereto in the specification (especially in the following claims) should be understood to include a singular form and plural forms. In addition, when there is no description explicitly specifying an order of operations of a method according to the present disclosure, the operations may be performed in an appropriate order. The present disclosure is not limited to the described order of the operations.

As used herein, phrases such as “in some embodiments” or “in an embodiment” does not necessarily indicate the same embodiment.

Some embodiments of the present disclosure may be represented by block components and various process operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” may be used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

In addition, as used herein, the terms such as “ . . . er (or)”, “ . . . unit”, “ . . . module”, etc., denote a unit that performs at least one function or operation, which may be implemented as hardware or software or a combination thereof.

In addition, as used herein, the term “user” refers to a person who uses an electronic device, and may include a consumer, an evaluator, a viewer, an administrator, or an installer.

Hereinafter, the present disclosure will be described in detail with reference to the accompanying drawings.

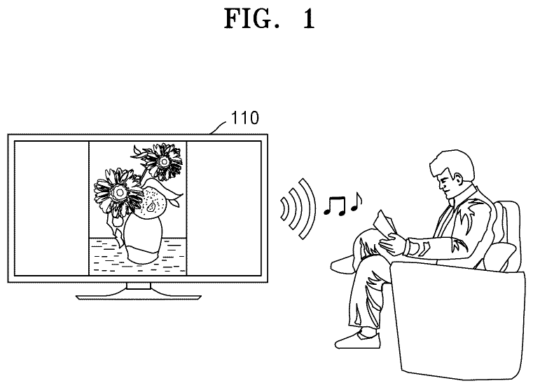

FIG. 1 is a diagram illustrating generating music and providing it to a user in consideration of the user's preference and situation, according to an embodiment.

Referring to FIG. 1, an electronic device 110 may output an image on a screen.

In an embodiment, the electronic device 110 may be implemented as various types of display devices including a screen. As an example, FIG. 1 illustrates a case where the electronic device 110 is a digital television (TV).

For example, the electronic device 110 may execute an ambient service to output an image on the screen. The ambient service may refer to a service for, when a display device such as a digital TV is turned off, displaying a meaningful screen such as a famous painting, a picture, or a clock, instead of a black screen. FIG. 1 illustrates an example where the electronic device 110 executes the ambient service to output ‘Sunflowers’, which is a famous painting by Vincent van Gogh, on the screen.

Alternatively, in another embodiment, the electronic device 110 may communicate with a peripheral device to output an image stored in the peripheral device on the screen of the electronic device 110. For example, the electronic device 110 may perform wired or wireless communication with a nearby user terminal such as a personal computer (PC) (not shown), a tablet (not shown), or a mobile phone (not shown), and output an image stored in the user terminal to the screen of the electronic device 110 through the communication.

In an embodiment, the electronic device 110 may obtain various pieces of situation information for music performance. In an embodiment, the situation information may refer to information indicating the user, the screen, or external circumstances or conditions around the user. The situation information may include at least one of user situation information, screen situation information, and external situation information.

In an embodiment, the user situation information may refer to information indicating the user's circumstances or conditions. The user situation information may include at least one of user identification information, emotion information, and activity information.

The user identification information may be information for identifying a speaker. The emotion information may be information indicating the speaker's emotional state identified from the speaker's voice. The activity information may refer to information about an action performed by an identified user while the electronic device 110 outputs the image.

In an embodiment, the electronic device 110 may collect audio signals and obtain user situation information by using the audio signals. The electronic device 110 may separate a voice and noise from the audio signals. In an embodiment, the electronic device 110 may identify the user based on the voice. In an embodiment, the electronic device 110 may obtain emotion information indicating that the user is currently in a mild-emotion state, based on a voice of the identified user.

In an embodiment, the electronic device 110 may obtain information about an activity performed by the user, based on at least one of a voice and noise. For example, FIG. 1 illustrates a case where the user is reading while the electronic device 110 outputs an image. In this case, based on the user's voice being barely heard and an environmental sound of turning pages being identified as noise, the electronic device 110 may identify that the user is currently performing an quiet activity, such as contemplating, studying, or reading.

In an embodiment, the electronic device 110 may obtain screen situation information from the image displayed on the screen. The screen situation information is information about the image displayed on the screen, and may include at least one of style information and color information of the image. The style information of the image is information representing the style of the image, and may include, but is not limited to, a unique feature of the image or a style indicating the painting style of the image.

For example, when the image output on the screen by the electronic device 110 is Sunflowers that is a famous painting by Vincent van Gogh as illustrated in FIG. 1, the electronic device 110 may analyze the image output on the screen to obtain at least one of information that style information of the image is a Vincent van Gogh-style famous painting, and information that the color is dark yellow.

In an embodiment, the electronic device 110 may obtain external situation information. The external situation information may refer to information indicating a surrounding or external situation of the location of the electronic device 110 and the user. For example, the external situation information may include at least one of weather information, date information, time information, season information, illuminance information, and location information.

For example, in FIG. 1, the electronic device 110 may obtain information that an ambient temperature is 20° C., through a sensor (not shown), or obtain information that the illuminance is 300 lux (lx), through an ambient brightness. Alternatively, the electronic device 110 may obtain, from an external server connected thereto through a communication module (not shown), information that the current time is afternoon, the surrounding weather is warm, the season is fall, today is September 5, and the location of the electronic device 110 is a suburb of Portland in Washington State, USA, and the like.

In an embodiment, the electronic device 110 may obtain user preference information. The user preference information may refer to information indicating the user's hobby or preferred direction. In an embodiment, when the user's previous music listening history is available, the electronic device 110 may obtain user preference information based on the previous music listening history. For example, the electronic device 110 may obtain, from a user preference information database (not shown), user preference information based on information about music that the user has listened to.

In an embodiment, the user preference information may include at least one of identification information of the user, mood information of music that the user has listened to, velocity information, instrument information, information about a frequency of reproduction of music, information about a time during which music has been reproduced, information about a screen situation when music is reproduced, and information about an external situation when music is reproduced.

For example, in FIG. 1, based on a previous music listening history of the user, the electronic device 110 may obtain user preference information, such as that the user's preferred music is classical music, quiet music, and music with a piano and a violin.

In an embodiment, the electronic device 110 may obtain sheet music for music performance, from at least one of the user situation information, the screen situation information, the external situation information, and the user preference information.

In an embodiment, the electronic device 110 may obtain sheet music for music performance from at least one of the situation information for music performance and the user preference information by using at least one neural network.

In an embodiment, the electronic device 110 may obtain multi-mood information from at least one of the user situation information and the screen situation information, by using a neural network. Hereinafter, for convenience of description, a neural network trained to obtain various pieces of mood information from at least one of user situation information and screen situation information will be referred to as a first neural network.

In an embodiment, the first neural network may include a softmax regression function. The first neural network may be a neural network trained to have a weight that minimizes a difference between a ground-truth set and a weighted sum of a weight and a at least one variable of the user situation information and the screen situation information.

For example, in FIG. 1, the electronic device 110 may obtain user situation information indicating that the user is quietly reading or studying, and screen situation information indicating that the image output on the screen is a yellow famous painting, and obtain information indicating various types of moods, for example, multi-mood information indicating quietness, comfort, peacefulness, nobility, boredom, or the like, by using the first neural network.

In an embodiment, by using a neural network, the electronic device 110 may obtain metadata from at least one of the user preference information, the external situation information, and the multi-mood information that is obtained through the first neural network. Hereinafter, for convenience of description, a neural network trained to obtain metadata from at least one of user preference information, external situation information, and multi-mood information will be referred to as a second neural network.

In an embodiment, the second neural network may include an encoder included in a transformer model. In addition, the second neural network may include an output layer that filters a weight output from the encoder of the transformer model.

In an embodiment, the electronic device 110 may embed at least one of the user preference information, the multi-mood information, and the external situation information and input a result of the embedding, into the encoder of the transformer model included in the second neural network.

In an embodiment, the electronic device 110 may obtain metadata by applying a softmax function as an output layer to the weight output from the encoder of the transformer model. For example, the electronic device 110 may obtain metadata of at least one of a tempo, a velocity, an instrument, and an ambient sound, by applying the softmax function to the weight output from the encoder of the transformer model.

In an embodiment, the electronic device 110 may obtain metadata by applying a fully connected layer as an output layer to the weight output from the encoder of the transformer model. For example, the electronic device 110 may obtain metadata of at least one of a pitch and a music performance length by applying the fully connected layer to a weight output from the encoder of the transformer model.

For example, the electronic device 110 may generate, from at least one of the user preference information, the external situation information, and the multi-mood information, metadata that the tempo of the music is slow, the velocity is normal, the instrument is a piano, the ambient sound is a gentle wind sound, the pitch is a medium tone, and the length of the music is 3 minutes.

In an embodiment, the electronic device 110 may obtain sheet music for music performance from the metadata by using a neural network. Hereinafter, for convenience of description, a neural network trained to obtain sheet music from metadata will be referred to as a third neural network.

In an embodiment, the third neural network may include a transformer-XL model.

In an embodiment, the electronic device 110 may embed the metadata obtained by using the second neural network into a format for input into the transformer-XL model, and input the embedded data into the transformer-XL model. The transformer-XL model may obtain a probability distribution of an event sequence by encoding and decoding the input data. In an embodiment, the electronic device 110 may obtain a probability distribution for each of various events such as a tempo, a velocity, or a pitch.

The electronic device 110 may obtain sheet music in bars by sampling the probability distribution of the event sequence.

In an embodiment, the electronic device 110 may feed forward a generated bar to the transformer-XL model to input it again into the transformer-XL model and obtain a probability distribution of a next event sequence from the transformer-XL model. The electronic device 110 may obtain a bar subsequent to the current bar by sampling the probability distribution of the next event sequence. The electronic device 110 may repeat this process to generate bars corresponding to the music performance length included in the metadata. The electronic device 110 may reproduce and output music according to sheet music composed of the generated bars.

As such, according to an embodiment, the electronic device 110 may obtain situation information for music performance, obtain user preference information, generate music that fits the user's situation and mood, based on at least one of the situation information and the user preference information, and provide the music to the user.

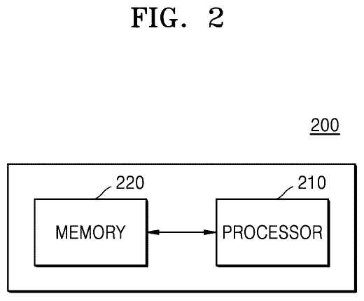

FIG. 2 is an internal block diagram of an electronic device according to an embodiment.

An electronic device 200 of FIG. 2 may be an example of the electronic device 110 of FIG. 1.

In an embodiment, the electronic device 200 may be implemented as various types of display devices capable of outputting an image through a screen. The display device may be a device for visually outputting an image to a user. For example, the electronic device 200 may include various types of electronic devices, such as a digital TV, a wearable device, a smart phone, various PCs (e.g., a desktop, a tablet PC, or a laptop computer), a personal digital assistant (PDA), or a global positioning system (GPS) device, a smart mirror, an electronic book terminal, a navigation device, a kiosk, a digital camera, a smart watch, a home network device, a security device, or a medical device. The electronic device 200 may be stationary or mobile.

Alternatively, the electronic device 200 may be in the form of a display inserted into a front surface of various types of home appliances such as a refrigerator or a washing machine.

Alternatively, the electronic device 200 may be implemented as an electronic device connected to a display device including a screen through a wired or wireless communication network. For example, the electronic device 200 may be implemented in the form of a media player, a set-top box, or an artificial intelligence (AI) speaker.

In addition, the electronic device 200 according to an embodiment of the present disclosure may be included in or mounted on the above-described various types of electronic devices, such as a digital TV, a wearable device, a smart phone, various PCs (e.g., a desktop, a tablet PC, or a laptop computer), a PDA, or a GPS device, a smart mirror, an electronic book terminal, a navigation device, a kiosk, a digital camera, a smart watch, a home network device, a security device, a medical device, a display inserted into a front surface of various types of home appliances such as a refrigerator or a washing machine, a media player, a set-top box, or an AI speaker.

Referring to FIG. 2, the electronic device 200 may include a processor 210 and a memory 220.

The memory 220 according to an embodiment may store at least one instruction. The memory 220 may store at least one program to be executed by the processor 210. A predefined operation rule or program may be stored in the memory 220. In addition, the memory 220 may store data input to or output from the electronic device 200.

The memory 220 may include at least one of a flash memory-type storage medium, a hard disk-type storage medium, a multimedia card micro-type storage medium, a card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disk, or an optical disc.

In an embodiment, the memory 220 may include one or more instructions for obtaining situation information for music performance.

In an embodiment, the memory 220 may include one or more instructions for obtaining user preference information.

In an embodiment, the memory 220 may include one or more instructions for updating a user preference information database by adding user preference information to the user preference information database.

In an embodiment, the memory 220 may store software for obtaining sheet music for music performance.

In an embodiment, the memory 220 may include one or more instructions for obtaining sheet music for music performance from at least one of situation information for music performance and user preference information by using at least one neural network.

In an embodiment, the memory 220 may store at least one neural network and/or a predefined operation rule or AI model. In an embodiment, the memory 220 may store a first neural network for obtaining multi-mood information from at least one of user situation information and screen situation information.

In an embodiment, the memory 220 may store a second neural network for obtaining metadata from at least one of user preference information, multi-mood information, and external situation information.

In an embodiment, the memory 220 may store a third neural network for obtaining sheet music for music performance from metadata.

In an embodiment, the processor 210 controls the overall operation of the electronic device 200. The processor 210 may execute one or more instructions stored in the memory 220 to control the electronic device 200 to function.

In an embodiment, the processor 210 may obtain situation information for music performance. The situation information for music performance may include at least one of user situation information, screen situation information, and external situation information.

In an embodiment, the user situation information may include at least one of user identification information, activity information, and emotion information.

In an embodiment, the processor 210 may obtain user situation information from at least one of a voice and noise. To this end, the processor 210 may separate a voice and noise from an input audio signal. In an embodiment, the processor 210 may identify the user based on the voice, obtain emotion information of the identified user based on a voice of the user, or obtain information about an activity performed by the user based on at least one of the voice and the noise.

In an embodiment, the processor 210 may execute one or more instructions stored in the memory 220 to obtain screen situation information based on at least one of style information and color information of an image output on the screen.

In an embodiment, the processor 210 may execute one or more instructions stored in the memory 220 to receive an input of at least one of weather information, date information, time information, season information, illuminance information, and location information through at least one of a sensor and the communication module, and obtain external situation information through the input.

In an embodiment, the processor 210 may obtain user preference information. In an embodiment, the user preference information may include at least one of identification information of the user, mood information, velocity information, ambient sound information, and instrument information of music that the user has listened to, information about a frequency of reproduction of the music, information about a time during which the music has been reproduced, information about a screen situation when the music is reproduced, and information about an external situation when the music is reproduced.

In an embodiment, the processor 210 may execute one or more instructions stored in the memory 220 to obtain sheet music for music performance from at least one of situation information for music performance and user preference information by using at least one neural network.

In an embodiment, the processor 210 may use AI technology. AI technology may include machine learning (deep learning) and element techniques utilizing machine learning. AI technology may be implemented by using an algorithm. Here, an algorithm or a set of algorithms for implementing AI technology is refer to as a neural network. The neural network may receive input data, perform computations for analysis and classification, and output resulting data. In order for the neural network to accurately output resulting data corresponding to input data, it is necessary to train the neural network. Here, the term ‘training’ may refer to training a neural network such that the neural network may discover or learn on its own a method of analyzing various pieces of data input to the neural network, a method of classifying the input pieces of data, and/or a method of extracting, from the input pieces of data, features necessary for generating resulting data. Training a neural network means that an AI model with desired characteristics is generated by applying a learning algorithm to a plurality of pieces of training data. In an embodiment of the disclosure, such training may be performed by the electronic device 200 that performs AI, or by a separate server/system.

Here, the learning algorithm is a method of training a certain target device (e.g., a robot) by using a plurality of pieces of training data to allow the target device to make a decision or make a prediction by itself. Examples of the learning algorithm include supervised learning, unsupervised learning, semi-supervised learning, or reinforcement learning, and a learning algorithm in an embodiment of the disclosure is not limited to the above-described examples except in cases in which it is specified.

A set of algorithms for outputting output data corresponding to input data through the neural network, or software and/or hardware for executing the set of algorithms may be referred to as an ‘AI model’ (or an ‘artificial intelligence model’, a ‘neural network model’, or a ‘neural network’).

The processor 210 may process input data according to predefined operation rules or an AI model. The predefined operation rules or AI model may be generated by using a particular algorithm. In addition, the AI model may be trained to perform a particular algorithm. The processor 210 may generate output data corresponding to input data through the AI model.

In an embodiment, the processor 210 may store at least one AI model. In an embodiment, the processor 210 may generate output data from input data by using a plurality of AI models. Alternatively, as described above, the memory 220, rather than the processor 210, may store AI models, that is, neural networks.

In an embodiment, the neural network used by the processor 210 may be a neural network trained to obtain sheet music for music performance from at least one of situation information and user preference information.

In an embodiment, processor 210 may use a set of neural networks.

In an embodiment, the processor 210 may obtain multi-mood information from at least one of user situation information and screen situation information, by using a first neural network trained to obtain multi-mood information from at least one of user situation information and screen situation information. In an embodiment, the first neural network may be a neural network that includes a softmax regression function and is trained to have a weight that minimizes a difference between a ground-truth set and a weighted sum of a weight and a at least one variable of user situation information and screen situation information.

In an embodiment, the processor 210 may obtain metadata from at least one of user preference information, multi-mood information, and external situation information, by using a second neural network. In an embodiment, the second neural network may include an encoder of a transformer model, and an output layer.

In an embodiment, the processor 210 may embed at least one of user preference information, multi-mood information, and external situation information, and input a result of the embedding into the encoder of the transformer model.

In an embodiment, the processor 210 may obtain metadata by applying a softmax function as an output layer to a weight output from the encoder of the transformer model. For example, the processor 210 may obtain metadata of at least one of a tempo, a velocity, an instrument, and an ambient sound, from the softmax function.

In an embodiment, the processor 210 may obtain metadata by applying a fully connected layer as an output layer to the weight output from the encoder of the transformer model. For example, the processor 210 may obtain metadata of at least one of a pitch and a music performance length, from the fully connected layer.

In an embodiment, the processor 210 may obtain sheet music for music performance from metadata by using a third neural network. In an embodiment, the third neural network may include a transformer model. In more detail, the neural network may include a transformer-XL model.

In an embodiment, the processor 210 may obtain a first probability distribution of an event sequence by embedding metadata and inputting a result of the embedding into the transformer-XL model. In an embodiment, the first probability distribution of the event sequence may include a probability distribution for each of a tempo, a velocity, and a pitch.

In an embodiment, the processor 210 may obtain one bar by sampling the first probability distribution of the event sequence. For convenience of description, the bar obtained by sampling the first probability distribution will be referred to as a first bar.

In an embodiment, processor 210 may execute one or more instructions stored in memory 220 to obtain a second probability distribution of a event sequence from the transformer-XL model by feeding forward the first bar to the transformer-XL model, and obtain a bar subsequent to the first bar by sampling the second probability distribution of the event sequence. For convenience of description, the bar subsequent to the first bar may be referred to as a second bar.

In an embodiment, the processor 210 may cause music to be reproduced according to sheet music for music performance.

In an embodiment, the processor 210 may add information about the reproduced music to the user preference information database that stores information related to music reproduction, to update the user preference information database.

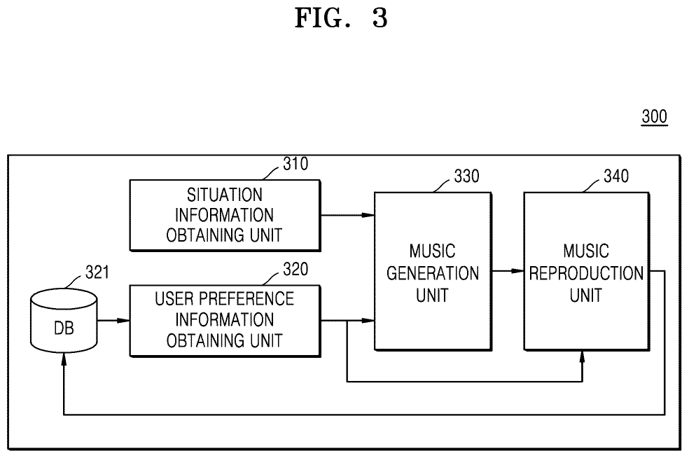

FIG. 3 is an internal block diagram of a processor included in an electronic device according to an embodiment.

Referring to FIG. 3, a processor 300 of FIG. 3 may be an example of the processor 210 of FIG. 2. The processor 300 may include a situation information obtaining unit 310, a user preference information obtaining unit 320, a user preference information database 321, a music generation unit 330, and a music reproduction unit 340.

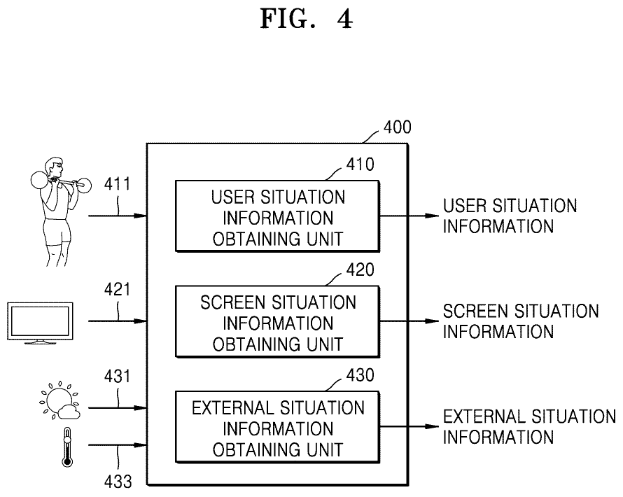

The situation information obtaining unit 310 according to an embodiment may obtain various pieces of situation information for music performance. In an embodiment, the situation information may refer to information indicating a user, a screen, or external circumstances or conditions. In an embodiment, the situation information may include at least one of user situation information, screen situation information, and external situation information. A method, performed by the situation information obtaining unit 310, of obtaining situation information will be described in more detail below with reference to FIGS. 4 to 6.

The user preference information obtaining unit 320 according to an embodiment may obtain user preference information. The user preference information may be information about a user's preferred music. The user preference information obtaining unit 320 may obtain user preference information based on the user's previous music listening history.

In an embodiment, the user preference information obtaining unit 320 may obtain user preference information from the user preference information database 321. The user preference information database 321 may be included in the electronic device together with the user preference information obtaining unit 320. FIG. 3 illustrates a case where the user preference information obtaining unit 320 is included in the electronic device, but this is merely an embodiment, and the user preference information database 321 may be physically separated from the electronic device. For example, the user preference information obtaining unit 320 may be stored in an external device connected to the electronic device through a communication network. Here, the external device may include another electronic device used by the user. Alternatively, the user preference information obtaining unit 320 may be stored in an external server or the like.

In an embodiment, the electronic device may obtain user preference information for each user. When the user is listening to music by using the electronic device, the electronic device may obtain user preference information based on information about the music that the user is listening to.

In an embodiment, the electronic device may obtain user identification information. The user identification information is information for identifying the user, and may be generated based on the user's voice. In an embodiment, the electronic device does not need to register the user's voice in advance for user identification information, and may generate user identification information by assigning a unique identifier (ID) to each anonymous user based on the user's voice recognized through an audio signal.

In an embodiment, the electronic device may obtain, as user preference information, at least one of mood information, velocity information, ambient sound information, instrument information, reproduction frequency information indicating an extent to which the user has listened to the music, music reproduction time information indicating whether the user listened to all or only part of the music or the like, information about a screen situation when the music is reproduced, and information about an external situation when the music is reproduced.

In an embodiment, the electronic device may map the user identification information with the user preference information, and store a result of the mapping in the user preference information database 321.

For example, when the mother among a family members listens to music by using the electronic device, the electronic device may generate an ID for the mother, that is, user identification information, based on the mother's voice, and obtain the mother's preference information by obtaining the mood, velocity, ambient sound, instrument, reproduction frequency, and music reproduction time of the music that the mother listens to, screen situation information indicating the style or color of an image displayed on the screen while the music is reproduced, external situation information such as the weather, time, season, illuminance, and the like when the music is being reproduced. The electronic device may map the mother's ID with the mother's preference information, and store a result of the mapping in the user preference information database 321.

Thereafter, when the mother wants to listen to music again, the electronic device may obtain the mother's preference information previously stored in the user preference database 321 along with situation information for music performance, and uses them to obtain sheet music for music performance. The music reproduction unit 340 of the electronic device may reproduce music according to newly generated sheet music. Then, the electronic device may receive information about the mother listening to music from the music reproduction unit 340, and additionally obtain information about the mother's preference information based on the received information. The electronic device may update the mother's preference information by adding the additionally obtained mother's preference information to the mother's preference information previously stored in the user preference database 321.

In a case where there are other family members using the electronic device to listen to music, for example, in a case where the father or a child also listens to music by using the electronic device, the electronic device may obtain an ID for each of the father and child and their music preference information, map the music preference information with the IDs of the father and child, and store a result of the mapping in the user preference database 321.

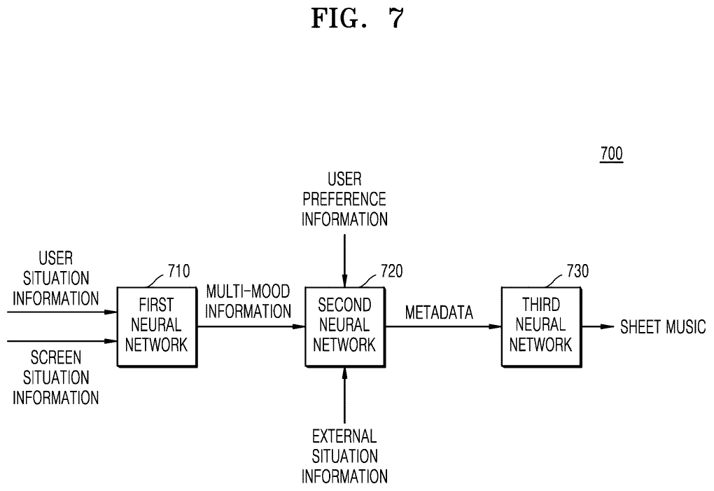

The music generation unit 330 according to an embodiment may receive situation information for music performance from the situation information obtaining unit 310, and receive user preference information from the user preference information obtaining unit 320. The music generation unit 330 may obtain sheet music for music performance based on at least one of the situation information for music performance and the user preference information by using at least one neural network. A method, performed by the music generation unit 330, of obtaining sheet music for music performance by using a neural network will be described in more detail below with reference to FIGS. 7 to 10.

The music reproduction unit 340 according to an embodiment may reproduce music according to sheet music generated by the music generation unit 330.

The music reproduction unit 340 may receive sheet music for music performance from the music generation unit 330, and synthesize a reproducible music file from the sheet music. For example, the music reproduction unit 340 may synthesize a music file such as mp3, midi, or wav, from the sheet music. The music reproduction unit 340 may reproduce the music file by using a music player.

In an embodiment, when there is ambient sound information among user preferences, the music reproduction unit 340 may receive information about an ambient sound preferred by the user, through the user preference information obtaining unit 320.

The ambient sound information may refer to a sound effect or a background sound to be reproduced along with music. The ambient sound may be generated in various forms, ranging from natural sounds such as a raining sound, a water sound, a forest sound, a wind sound, a waterfall sound, an insect sound, or a bird sound, to car noise, crowd noise, an airport terminal sound, a space travel sound, and the like. The ambient sound may be generated by using mainly a piano, a synthesizer, and a string instrument, and may be used to create a unique atmosphere. For example, the ambient sound may be used to create various atmospheres, such as a calm and contemplative atmosphere, a tense and scary atmosphere, a dreamy atmosphere, an atmosphere expressing the mystery of nature or the spirit of life, a gloomy and dark atmosphere, a romantic atmosphere, or a peaceful and bright atmosphere.

In addition, the ambient sound may be implemented as a drum rhythm with a sense of beat or a high-fidelity (hi-fi) or low-fidelity (lo-fi) sound source. Hi-fi may refer to a method of listening with clean, good sound quality that is as close to an original sound as possible, while lo-fi may refer to intentional implementation of a low-quality audio sound or to music that is recorded in such a way.

The music reproduction unit 340 may receive the information about the ambient sound preferred by the user from the user preference information obtaining unit 320, combine the information with a music file, and reproduce a result of the combining.

The user may listen to music reproduced by the music reproduction unit 340. The user may like the music and thus listen to it several times, or may not like the music and thus stop reproduction of the music before it ends.

The electronic device may analyze the music that the user has listened to, and obtain user preference information in consideration of a frequency at which the user has listened to the music, or a reproduction length for which the user has listened to the music. The electronic device may add user preference information to the user preference information database 321 to update the user's preference information.

FIG. 4 is an internal block diagram of a situation information obtaining unit included in an electronic device, according to an embodiment.

A situation information obtaining unit 400 of FIG. 4 may be an example of the situation information obtaining unit 310 included in the processor 300 of FIG. 3.

Referring to FIG. 4, the situation information obtaining unit 400 may include a user situation information obtaining unit 410, a screen situation information obtaining unit 420, and an external situation information obtaining unit 430.

The user situation information obtaining unit 400 according to an embodiment may obtain user situation information for music performance. In an embodiment, the user situation information may refer to information indicating the user's circumstances or conditions.

In an embodiment, the situation information obtaining unit 400 may obtain user situation information by using an audio signal 411. The audio signal 411 may include a human voice or other background noise. In order to collect audio signals, the electronic device may include a microphone (not shown) capable of collecting the audio signal 411. Alternatively, the electronic device may receive, through a communication network, the audio signal 411 collected through an external microphone.

The audio signal 411 may include background noise in addition to the user's voice.

The situation information obtaining unit 400 may separate a voice and noise from the audio signal 411. In an embodiment, the situation information obtaining unit 400 may identify the user by using the voice. For example, the situation information obtaining unit 400 may determine whether the user's voice has been input before, and when the user's voice has been input before, identify a user ID from a user model. Alternatively, when the user's voice has not been input before, the situation information obtaining unit 400 may generate a user model by matching the user's voice with a new ID.

In an embodiment, the situation information obtaining unit 400 may obtain emotion information of an identified user. The emotion information may be information indicating the user's emotional state identified from the user's voice.

In an embodiment, the situation information obtaining unit 400 may obtain information about an activity performed by the user, based on at least one of the voice and the noise. The activity information may refer to information indicating an action performed by the identified user.

As an example, assume the user is exercising. The situation information obtaining unit 400 may identify, as the user's voice, an intermittently heard sound of heavy breathing, grunting, or the like, from the audio signal 411. In addition, the situation information obtaining unit 400 may identify, as noise, a sound of a weight falling on the floor or the like, from the audio signal 411.

The situation information obtaining unit 400 may identify the user through the user's voice. The situation information obtaining unit 400 may identify that the user is excited, intense, or tense, through the identified user's voice.

The situation information obtaining unit 400 may identify that the activity performed by the user is exercise or strenuous work, through the user's voice and the noise.

The situation information obtaining unit 400 may generate user situation information including at least one of user identification information, emotion information, and activity information.

The screen situation information obtaining unit 420 according to an embodiment may obtain screen situation information from an image 421 output on the screen of the electronic device. The screen situation information may refer to information about an image displayed on the screen. The screen situation information may include style information of the image. The style information of the image may be information indicating the style of the image. The screen situation information may include color information. For example, the color information may be red-green-blue (RGB) values of the most used color in the image.

The external situation information obtaining unit 430 according to an embodiment may receive at least one of a communication signal 431 and a sensor signal 433. The external situation information obtaining unit 430 may newly obtain at least one of the communication signal 431 and the sensor signal 433, at set or random time intervals, at preset time points, or whenever an event occurs, such as a sudden change in temperature or a change in date.

The communication signal 431 may be a signal obtained from an external server or the like through a communication network, and may include at least one of information indicating an external situation, such as external weather information, date information, time information, season information, illuminance information, and location information.

The external situation information obtaining unit 430 according to an embodiment may obtain a sensor signal about an external situation around the electronic device by using various sensors. The sensor signal 433 may be a signal sensed by a sensor, and may include various types of signals depending on the type of the sensor.

For example, the external situation information obtaining unit 430 may detect an ambient temperature or humidity by using a temperature/humidity sensor. Alternatively, the external situation information obtaining unit 430 may detect an ambient illuminance of the electronic device by using an illuminance sensor. The illuminance sensor may measure the amount of ambient light to measure the brightness according to the amount of ambient light. Alternatively, the external situation information obtaining unit 430 may detect the location of the electronic device by using a location sensor. Alternatively, the external situation information obtaining unit 430 may detect the distance between the electronic device and the user by using a location sensor and/or a proximity sensor. Alternatively, the external situation information obtaining unit 430 may obtain a signal about an ambient air pressure or proximity of an object, from at least one sensor selected from a barometric sensor and a proximity sensor, but is not limited thereto.

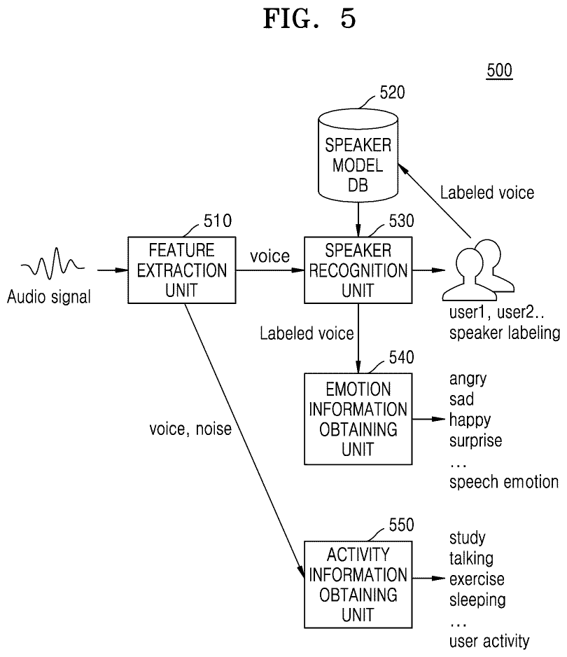

FIG. 5 is a diagram for describing a method, performed by a user situation information obtaining unit, of obtaining user situation information, according to an embodiment.

A user situation information obtaining unit 500 of FIG. 5 may be an example of the situation information obtaining unit 410 of FIG. 4. Referring to FIG. 5, the user situation information obtaining unit 500 may include a feature extraction unit 510, a speaker model database 520, a speaker recognition unit 530, an emotion information obtaining unit 540, and an activity information obtaining unit 550.

The user situation information obtaining unit 500 may collect audio signals through a microphone array (not shown). The microphone array may collect audio signals, including voices and background noise, and convert an analog audio signal into a digital signal.

In an embodiment, the feature extraction unit 510 may separate a voice and noise from the collected audio signal. In an embodiment, the feature extraction unit 510 may separate a voice and noise from the audio signal by using a convolutional neural network (CNN) model such as Wave-U-NET, but is not limited to thereto.

In an embodiment, the feature extraction unit 510 may obtain feature information from a voice. The feature information may be expressed in the form of a feature vector. In an embodiment, the feature extraction unit 510 may convert a time domain-based voice signal into a signal in a frequency domain, and extract a feature vector by differently modifying frequency energy of the converted signal.

In an embodiment, the feature extraction unit 510 may obtain, as feature information, at least one of various parameters obtained through digitization, frequency conversion, or the like of the voice, such as pitch, formant, linear predictive cepstral coefficient (LPCC), mel-frequency cepstral coefficient (MFCC), or perceptual linear predictive (PLP). For example, the feature extraction unit 510 may obtain feature information from the voice by using an MFCC algorithm. The MFCC algorithm is a technique for dividing a voice into small frames of about 20 ms to about 40 ms, and analyzing the spectrum of the frames to extract features, and has the advantage of consistently extracting feature information by using MFCC even when the pitch changes.

The speaker recognition unit 530 may receive the voice and/or the feature information of the voice from the feature extraction unit 510, and perform speaker recognition based on the received information. Speaker recognition refers to a function of generating a speaker model based on a recognized voice, determining whether the recognized voice is a speaker voice by a previously generated speaker model, or determining whether to perform a certain subsequent operation based on the determining.

In an embodiment, a speaker model may be stored in the speaker model database 520.

In an embodiment, before generating a speaker model, the speaker recognition unit 530 may identify whether the speaker model to be generated already exists. For example, the speaker recognition unit 530 may identify whether there is a speaker model previously generated in relation to an input voice, based on whether there is a speaker model of which the similarity to feature information of the input voice is greater than or equal to a reference value. When there is a speaker model of which the similarity to the feature information of the input voice is greater than or equal to the reference value, the speaker recognition unit 530 may identify the speaker based on the input voice. In an embodiment, the speaker recognition unit 530 may update the speaker model by adding features of the input voice to the speaker model.

In an embodiment, when there is no speaker model of which the similarity to the feature information of the voice is greater than or equal to the reference value, the speaker recognition unit 530 may generate a new speaker model based on the voice. For the input voice, the speaker recognition unit 530 may convert a time domain-based voice signal into a signal in a frequency domain, and extracts a feature vector for speaker recognition by differently modifying frequency energy of the converted signal. For example, the feature vector for speaker recognition may be MFCCs or Filter Bank Energy, but is not limited thereto. The speaker recognition unit 530 may generate a speaker model by using a covariance obtained by using feature vectors.

In an embodiment, the speaker recognition unit 530 may assign user identification information to each speaker model. For example, the speaker recognition unit 530 may assign a unique ID to each speaker model based on the speaker's voice, to label each speaker as, for example, user 1, user 2, and the like.

In an embodiment, the generated speaker model may be stored in the speaker model database 520 along with the unique ID assigned to each model.

The speaker recognition unit 530 may identify a speaker from a voice, and deliver a voice of the labeled speaker to the emotion information obtaining unit 540.

In an embodiment, the emotion information obtaining unit 540 may obtain emotion information indicating the labeled speaker's emotion by using the voice.

In an embodiment, the emotion information obtaining unit 540 may perform a short-time Fourier transform (STFT) on the voice to obtain a frequency value of the voice over time. The emotion information obtaining unit 540 may obtain emotion information of the labeled speaker by inputting frequency value over time into a neural network trained to obtain emotion information from a voice. For example, the emotion information obtaining unit 540 may train an emotion model by using one or more various types of neural networks having high performance in classification among machine learning algorithms, such as support vector machine, random forest, or xgboost algorithm, and mix and use results of classifying results of the training. The emotion information obtaining unit 540 may obtain emotion information of the speaker from the speaker's voice by analyzing and classifying the speaker's voice by using the trained emotion model. For example, the emotion information obtaining unit 540 may classify the speaker's emotion into various types of emotions, to obtain values respectively indicating levels of anger, sadness, happiness, surprise, and the like for the speaker's emotion.

In an embodiment, the activity information obtaining unit 550 may receive at least one of a voice and noise from the feature extraction unit 510, and identify an activity performed by the speaker from the received information. In an embodiment, the activity information obtaining unit 550 may obtain a frequency value over time by performing an STFT on at least one of a voice and noise, and input the frequency value into a CNN model, to obtain, as a result, a classification value for the activity performed by the speaker. When the correlation between pieces of information included in input data is local, a CNN-based neural network may generate output data by introducing the concept of a filter that illuminates only a particular region and performing convolution on pieces of information in the filter.

In an embodiment, the activity information obtaining unit 550 may obtain the classification value indicating the activity performed by the speaker, from at least one of the voice and the noise through the CNN-based neural network. For example, the activity information obtaining unit 550 may classify an action into various activities, and obtain, as a result, numerical values corresponding to respective actions indicating which action the speaker is performing, for example, whether the speaker is studying, having a conversation, exercising, sleeping, or the like.

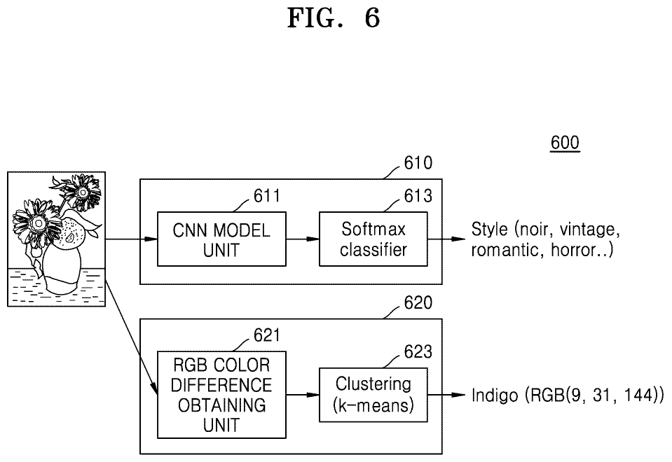

FIG. 6 is a diagram illustrating a method, performed by a screen situation information obtaining unit, of obtaining screen situation information, according to an embodiment.

A screen situation information obtaining unit 600 of FIG. 6 may be an example of the screen situation information obtaining unit 420 of FIG. 4.

Referring to FIG. 6, the screen situation information obtaining unit 600 may include a style information obtaining unit 610 and a color information obtaining unit 620.

Style information may be information indicating the style of an image. The style information may be information indicating a unique feature of the image.

The style information may include information for identifying the type of an object detected in the image. For example, the style information may include information for identifying whether an object included in the image is a person, a nature object, a city, or the like.

When the image is a painting, the style information may include a style indicating a painting style. The style information may indicate a painting method or style, such as watercolor, oil painting, ink painting, pointillism, or stereogram, or may refer to the tendency and characteristics of a particular artist, such as Van Gogh style, Monet style, Manet style, or Picasso style. Alternatively, the style information may include a feature classified by era, such as medieval, Renaissance, modern, or contemporary paintings, or a feature classified by region, such as oriental paintings or western paintings, or a feature of a painting style such as Impressionism, Abstraction, or Realism. Alternatively, the style information may include information about the texture, color, atmosphere, contrast, gloss, or three elements of color, i.e., brightness, hue, and saturation, of the image.

Alternatively, when the image is a picture, the style information may include information about a camera shooting technique. For example, the style information may include information about whether the technique used for capturing the picture is panning shot, tilting shot, zooming shot, macro shot, or night view shot. Alternatively, the style information may include, but is not limited to, the composition of the subject, an angle of view, an exposure level, a lens type, a degree of blurring, a focus length, and the like.

The style information obtaining unit 610 may include a CNN model unit 611 and a softmax classifier 613. The CNN model unit 611 may include, for example, a ResNet model. The ResNet model is an algorithm developed by Microsoft, and is a network disclosed in the paper “Deep Residual Learning for Image Recognition”. ResNet has a structure designed to enable learning of even a deep network. ResNet basically has a structure obtained by adding convolutional layers to a structure of VGG-19 to generate a deep layer, and then adding shortcuts for adding an output value to an input value.

In an embodiment, the ResNet model used by the CNN model unit 611 may consist of 101 layers, but this is an merely embodiment, and the present disclosure is not limited thereto. A general ResNet model is a fully connected layer, but with 101 layers, the performance is significantly slow when implementing a fully connected layer. Thus, in an embodiment, the CNN model unit 611 may prevent the speed from decreasing by removing the fully connected layer from the ResNet model. That is, the CNN model unit 611 may extract features from an image by using a CNN model from which the fully connected layer is removed.

The softmax classifier 613 may obtain style information of the image by classifying, by style, the features extracted through ResNet. For example, the softmax classifier 613 may obtain various types of style information indicating which type the style of the image corresponds to, for example, whether an object included in the image is a person, an animal, or a nature object, whether the style of the image is noir, vintage, romantic, or fear, or the like.

The color information obtaining unit 620 according to an embodiment may obtain color information from an image. The color information may be RGB values of the most used color in the image.

The color information obtaining unit 620 may include an RGB color difference obtaining unit 621 and a clustering unit 623. The RGB color difference obtaining unit 621 may group the RGB values of each pixel into similar colors through a color difference algorithm. The clustering unit 623 may obtain RGB values corresponding to one dominant color for each image by clustering dominant colors from the grouped colors.

FIG. 7 is a diagram for describing obtaining, by an electronic device, sheet music for music performance from at least one of situation information and user preference information, according to an embodiment.

The electronic device may include a music generation unit 700. The music generation unit 700 may be an example of the music generation unit 330 included in the processor 300 of FIG. 3.

In an embodiment, the music generation unit 700 may generate final output data from input data by using a plurality of AI models.

Referring to FIG. 7, the music generation unit 700 may include a first neural network 710, a second neural network 720, and a third neural network 730.

The first neural network 710, the second neural network 720, and the third neural network 730 are AI models that has learned predefined operation rules or particular algorithms, and may generate output data corresponding to input data.

In an embodiment, the first neural network 710 may be a neural network trained to have a weight that minimizes a difference between a ground-truth set and a weighted sum of a weight and a at least one variable of user situation information and screen situation information.

In an embodiment, the first neural network 710 may receive, as input data, at least one of user situation information and screen situation information, and obtain multi-mood information from at least one of the user situation information and the screen situation information. In an embodiment, the first neural network 710 may be an algorithm for obtaining multi-mood information from input data, a set of such algorithms, or software and/or hardware for executing the set of algorithms. In an embodiment, the first neural network 710 may include a softmax regression function.

In an embodiment, the second neural network 720 may receive, as input data, multi-mood information obtained through the first neural network 710. In addition, the second neural network 720 may further receive an input of at least one of user preference information and external situation information. The second neural network 720 may receive at least one of multi-mood information, user preference information, and external situation information, and generate metadata from the received information.

In an embodiment, the second neural network 720 may be an algorithm for obtaining metadata about music from input data, a set of such algorithms, or software and/or hardware for executing the set of algorithms.

In an embodiment, the second neural network 720 may include an encoder included in a transformer model. The transformer model is a model disclosed in “Attention is all you need”, which is a paper published by Google in 2017, and employs an encoder-decoder that is a seq2seq structure, but is implemented only with attention as the title of the paper suggests.

In an embodiment, the second neural network 720 may include an output layer that filters a weight output from the encoder of the transformer model. In an embodiment, the second neural network 720 may obtain metadata by applying an output layer to a weight output from the encoder of the transformer model. The metadata may include at least one of a tempo, a velocity, an instrument, an ambient sound, a pitch, and a music performance length.

In an embodiment, the third neural network 730 may obtain sheet music for music performance from metadata.

In an embodiment, the third neural network 730 may be an algorithm for generating sheet music from input data, a set of such algorithms, or software and/or hardware for executing the set of algorithms.

In an embodiment, the third neural network 730 may include a transformer model. In more detail, the third neural network 730 may include a transformer-XL model.

In an embodiment, the third neural network 730 may embed metadata obtained by using the second neural network 720 into a format for input into the transformer-XL model, and input the embedded data into the transformer-XL model. The transformer-XL model may obtain a probability distribution of an event sequence by encoding and decoding the input data.

In an embodiment, the third neural network 730 may obtain a probability distribution for an event of each of a tempo, a velocity, and a pitch. In an embodiment, the third neural network 730 may obtain sheet music for music performance from a probability distribution for an event of each of a tempo, a velocity, and a pitch.

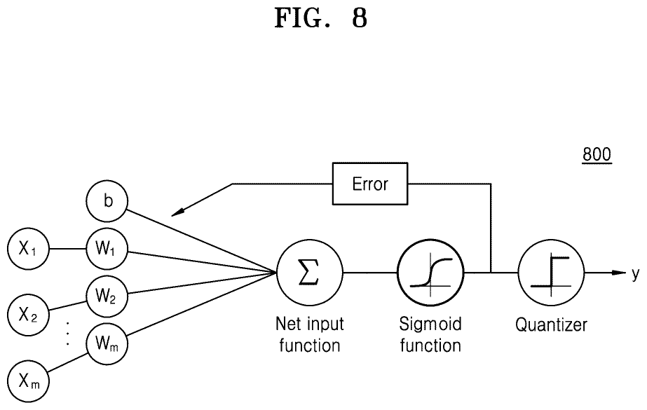

FIG. 8 is a diagram for describing an operation of a first neural network according to an embodiment.

In an embodiment, a first neural network 800 of FIG. 8 may be an example of the first neural network 710 included in the music generation unit 700 of FIG. 7.

In an embodiment, the first neural network 800 may be an algorithm for extracting features from at least one of user situation information and screen situation information, and obtaining multi-mood information from the features, a set of such algorithms, or software and/or hardware for executing the set of algorithms.

The first neural network 800 may be trained to receive input data, perform computations for analysis and classification, and output resulting data corresponding to the input data.

In an embodiment, the first neural network 800 may be trained to obtain multi-mood information, by receiving various pieces of user situation information and screen situation information as a plurality of pieces of training data, and applying a learning algorithm to the plurality of pieces of training data. Such training may be performed by the electronic device that performs AI, or by a separate external server/system.

Music has beginning, development, climax, conclusion phases. When music is created with one tone or the same pattern, a user listening to the music may feel bored, and thus, it may be preferable that music is created such that various moods are expressed in various forms while maintaining consistency in the larger frame. In addition, because emotions that a person feels or a surrounding situation are often a mixture of various emotions rather than being defined as a single emotion, it may be preferable that mood information is also expressed as various moods corresponding to various emotions rather than being expressed as a single emotion.

In an embodiment, the first neural network 800 may be trained to output various moods, that is, multi-mood information. For example, the first neural network 800 does not obtain only one mood as a result, but may be trained to express surrounding situations or emotions in various moods, such as happiness, warmth, or dreaminess.

In an embodiment, the first neural network 800 may use a softmax regression function to obtain various moods as a result. The softmax function may be used when there are multiple choices (classes) for classification, that is, when performing multi-class prediction. When the total number of classes is k, the softmax function may receive an input of a k-dimensional vector, and estimate a probability for each class.

In an embodiment, the first neural network 800 may be a neural network that receives a k-dimensional vector to be trained such that a probability for each class obtained from the vector is equal to a ground-truth set.

When classification is into k classes, i.e., when k types of multi-mood information are obtained as a result of the classification, the first neural network 800 may receive an input by making an input data vector a k-dimensional vector.

In FIG. 8, x1, x2, . . . , xm are input variables and may refer to variable values for at least one of user situation information and screen information. In order to convert m input variables into k input variables, the first neural network 800 may apply weights to the input variables. In FIG. 8, w1, w2, . . . , wm may refer to weights to be applied to the respective variables. In addition, b may refer to a bias.

The first neural network 800 may generate a prediction value z by multiplying a matrix of the input variables by a matrix of the weights. z denotes a net input function and may be generated according to z=w1x1+w2v2+w3x3+ . . . +wmxm+b. The prediction value may refer to a probability that each class is correct. In order to convert the prediction value into a probability distribution, the first neural network 800 may use a softmax function. The softmax function may receive prediction values as input and obtain a probability distribution with a total sum of 1 as a result. The probability distribution may be obtained as a probability value for whether a result belongs to the corresponding class, through the sigmoid function.

The first neural network 800 may use a cost function to calculate, as an error, a difference between the probability value and the ground-truth set. For example, a cross entropy function may be used as the cost function, but the present disclosure is not limited thereto. The first neural network 800 may be trained in a repetitive loop until weights that minimize the error are obtained.

The trained first neural network 800 may receive an input of a variable value for at least one of user situation information and screen information. For example, the first neural network 800 may receive, as input, a variable value for activity information among user situation information as x1, a variable value for emotion information among the user situation information as x2, a variable value for style information of the image among screen situation information as x3, a variable value for color information of the image among the screen situation information as x4. The first neural network 800 may obtain a probability value for each class corresponding to multi-mood information by applying, to the input variables, weights generated to convert m input variables into k variables, i.e., weights w1, w2, . . . , wm. The probability values may be converted into discrete result values through a quantizer. A resulting value y may be in the form of a one-hot encoding vector. For example, the first neural network 800 may obtain, as multi-mood information y, a vector representing quietness, happiness, and passionateness, as 0.5, 0.3, and 0.2, respectively.

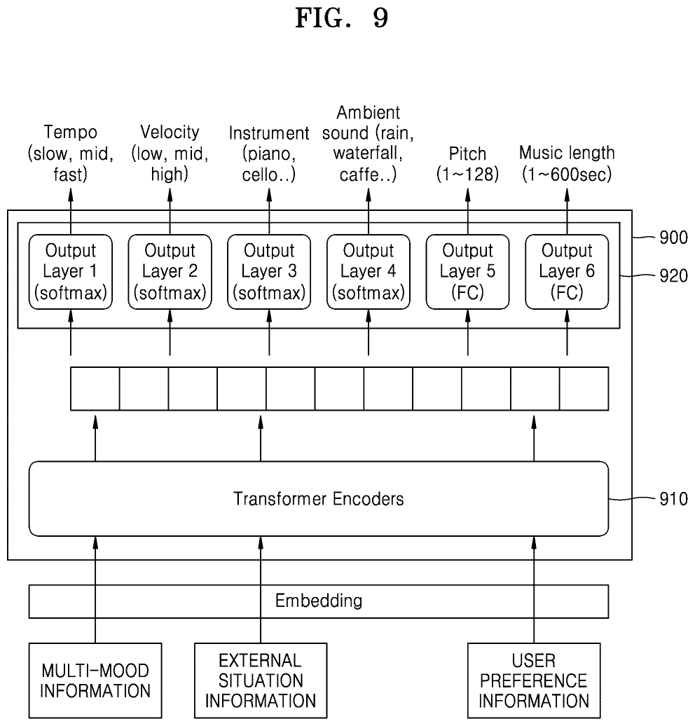

FIG. 9 is a diagram for describing an operation of a second neural network according to an embodiment.

In an embodiment, a second neural network 900 of FIG. 9 may be an example of the second neural network 720 included in the music generation unit 700 of FIG. 7.

In an embodiment, the second neural network 900 may be an algorithm for extracting features from at least one of user preference information, external situation information, and multi-mood information, and obtaining metadata from the features, a set of such algorithms, or software and/or hardware for executing the set of algorithms.

The second neural network 900 may receive, as training data, at least one of various pieces of user preference information, external situation information, and multi-mood information, and apply a learning algorithm to be trained to analyze and classify a plurality of training data to obtain metadata as resulting data corresponding to the training data. Such training may be performed by the electronic device that performs AI, or by a separate external server/system.

In an embodiment, the second neural network 900 may use a transformer model. In more detail, the second neural network 900 may use a Bidirectional Encoder Representations from Transformers (BERT) model. BERT is a pre-trained model released by Google in 2018, and is a model with a structure in which encoders of a transformer model are stacked. That is, the architecture of BERT uses the transformer model introduced in ‘Attention is all you need’, but may be a model that facilitates transfer learning by partially modifying an architecture in pre-training and fine-tuning.

The second neural network 900 may obtain an embedding vector by embedding input data. That is, the second neural network 900 may convert each input data into a vector by using an embedding algorithm. The embedded vector may be input into an encoder 910 of the BERT model. The encoder 910 of the BERT model is a stack of a plurality of encoder layers, and may perform multi-head self-attention and feed-forward operations for each layer. The encoder 910 of the BERT model may receive an embedded vector as input, pass the input vector to a ‘self-attention’ layer, then pass it to a subsequent feed-forward layer, and pass an output obtained from the feed-forward layer to a subsequent encoder.

The trained second neural network 900 may receive, as input data, at least one of multi-mood information, external situation information, and user preference information. The second neural network 900 may generate an embedding vector by embedding the input data and input the embedding vector into the encoder 910 of the BERT model to obtain a weight vector.

The second neural network 900 may obtain output data by filtering the weight vector to an output layer 920. In embodiments, the output data may include metadata about music.

In an embodiment, the second neural network 900 may use a softmax function as an output layer to obtain output data from the weight vector. In an embodiment, when the metadata obtained by the second neural network 900 using the softmax function as the output layer is referred to as first metadata, the first metadata may include metadata about at least one of a tempo, a velocity, an instrument, and an ambient sound. The first metadata may include information indicating the type of the metadata and which category the metadata belongs to. For example, when the first metadata is a tempo, the first metadata may indicate whether the tempo is slow, medium, or fast with values of 0.5, 0.3, and 0.2, respectively.

In an embodiment, the second neural network 900 may obtain metadata by applying, to the weight vector, a fully connected layer as an output layer. The metadata such as a pitch or a music performance length may be obtained as a value that belong to a range rather than being identified through classification. Thus, the second neural network 900 may use a fully connected layer as an output layer to obtain a range value to which the pitch or music performance length belongs, from the weight vector. When the metadata obtained by using a fully connected layer as an output layer is referred to as second metadata, the second metadata may include at least one of a pitch and a music performance length. For example, the second metadata may include information indicating which value between 1 to 128 the pitch value corresponds to, or which length between 1 to 600 seconds the music performance length corresponds to.

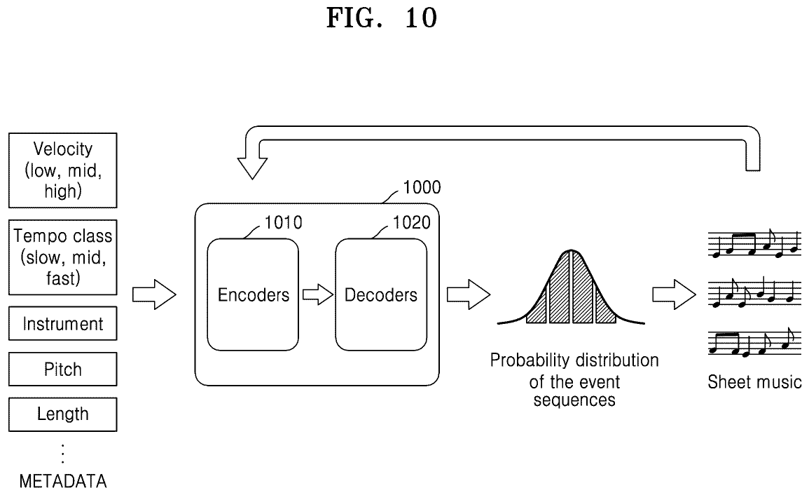

FIG. 10 is a diagram for describing an operation of a third neural network according to an embodiment.

In an embodiment, a third neural network 1000 of FIG. 10 may be an example of the third neural network 730 included in the music generation unit 700 of FIG. 7.

In an embodiment, the third neural network 1000 may be a neural network trained to obtain sheet music from various types of metadata.

In an embodiment, the third neural network 1000 may receive various types of metadata as training data. The metadata may include at least one of a tempo, a velocity, an instrument, an ambient sound, a pitch, and a music performance length. The third neural network 1000 may be trained to extract features by analyzing and classifying metadata, and obtain sheet music containing music information based on the extracted features. Such training may be performed by the electronic device that performs AI, or by a separate external server/system.

In an embodiment, the third neural network 1000 may include a transformer model. The transformer model is implemented with a context with a fixed length, thus, a dependency longer than the fixed length cannot be modeled, and context fragmentation occurs.

Thus, in an embodiment, the third neural network 1000 may use a transformer-XL model among transformer models. When being trained, the transformer-XL model may use a representation computed for a previous segment as an extended context, when processing the next segment. In addition, by using a relative position encoding method, it may learn not only the absolute position of each token, but also a position of each token relative to another token, which is significantly important in music.

In an embodiment, the third neural network 1000 may include an encoder 1010 and a decoder 1020. There may be N encoders 1010 and N decoders 1020. The encoder 1010 may receive embedded metadata as an input sequence, process the embedded metadata, and transmit the processed metadata to the decoder 1020. The decoder 1020 may process data received from the encoder 1010 and output an output sequence.

In an embodiment, the output sequence may be obtained as a probability distribution of an event sequence. The event sequence is a path in which events are listed, and may refer to a set of items with sequential relations representing a behavior of an object during a particular period of time, in the form of data describing the object, i.e., an event. Here, the event is information for generating sheet music, and may include various pieces of information, for example, a tempo, a velocity, a pitch, and positions of notes (intervals).

An event sequence probability distribution may include a probability distribution for an event sequence obtained for each event. That is, the third neural network 1000 may obtain an event sequence probability distribution for each event, such as a probability distribution for a tempo, a probability distribution for a velocity, a probability distribution for a pitch, and a probability distribution for a position of a note.

In an embodiment, the third neural network 1000 may sample an event sequence probability distribution and generate sheet music from a result of the sampling. The third neural network 1000 may generate sheet music in one bar unit by sampling the event sequence probability distribution generated for each event.

In an embodiment, the third neural network 1000 may sample the event sequence probability distribution by using various sampling techniques. For example, the third neural network 1000 may perform top-k sampling to generate one bar by picking a value with the highest probability distribution from the event sequence probability distribution for each of the tempo, the velocity, the pitch, and the interval. Alternatively, the third neural network 1000 may perform nucleus sampling to perform sampling by considering a probability value.

In an embodiment, when there are two or more types of instruments included in the metadata, for example, a piano and a violin, the third neural network 1000 may generate a bar for each instrument, i.e., for each of the piano and the violin.

In an embodiment, the third neural network 1000 receives, as input, the generated bar back into the encoder 1010, and processes the data through the encoder 1010 and the decoder 1020 to obtain again an event sequence probability distribution for each event. The third neural network 1000 may generate a bar subsequent to the previous bar by resampling the event sequence probability distribution obtained for each event.

The third neural network 1000 may repeatedly perform a process of generating a next bar by referring to the bar that has been previously generated. The third neural network 1000 may repeat the above process for a period of time corresponding to the music performance length included in the metadata.

As such, according to an embodiment, the third neural network 1000 generates the next bar by referring to the previous bar, and thus may generate music with an overall similar atmosphere. In addition, according to an embodiment, the third neural network 1000 generates a bar by sampling the event sequence probability distribution, and thus generate different pieces of information for respective bars even when the same event sequence probability distribution is used.

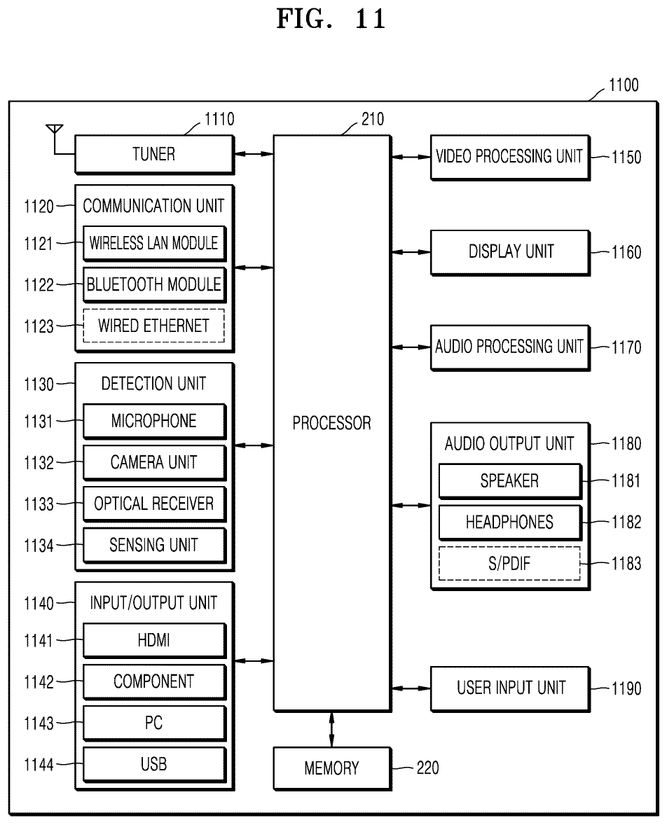

FIG. 11 is an internal block diagram of an electronic device according to an embodiment of the disclosure.

An electronic device 1100 of FIG. 11 may include components of the electronic device 200 of FIG. 2. Components of the electronic device 1100 of FIG. 11 that are the same as those of the electronic device 200 of FIG. 2 are assigned the same reference numerals. Hereinafter, descriptions that are provided above with reference to FIG. 2 will be omitted.

Referring to FIG. 11, in addition to the processor 210 and the memory 220, the electronic device 1100 may further include a tuner 1110, a communication unit 1120, a detection unit 1130, an input/output unit 1140, a video processing unit 1150, a display unit 1160, an audio processing unit 1170, an audio output unit 1180, and a user input unit 1190.

The tuner 1110 may be tuned to and select only a frequency of a channel desired to be received by the electronic device 1100 from among a number of radio wave components by performing amplification, mixing, resonance, or the like on broadcast content or the like received in a wired or wireless manner. Content received through the tuner 1110 is decoded to be separated into an audio, a video, and/or additional information. The audio, video, and/or additional information may be stored in the memory 220 under control of the processor 210.

The communication unit 1120 may connect the electronic device 1100 to a peripheral device, an external device, a server, a mobile terminal, or the like, under control of the processor 210. The communication unit 1120 may include at least one communication module capable of performing wireless communication. The communication unit 1120 may include at least one of a wireless local access network (WLAN) module 1121, a Bluetooth module 1122, and a wired Ethernet module 1123, in accordance with the performance and structure of the electronic device 1100.

The Bluetooth module 1122 may receive a Bluetooth signal transmitted from a peripheral device according to a Bluetooth communication standard. The Bluetooth module 1122 may be a Bluetooth Low Energy (BLE) communication module, and may receive a BLE signal. The Bluetooth module 1122 may continuously or temporarily perform BLE signal scanning to detect whether a BLE signal is received. The WLAN module 1121 may transmit and receive a Wi-Fi signal to and from a peripheral device according to a Wi-Fi communication standard.

In an embodiment, the communication unit 1120 may use a communication module to obtain various pieces of information indicating an external situation, such as information about the weather, time, date, or the like, from an external device or server, and transmit the information to the processor 210.

The detection unit 1130 may detect a voice, an image, or an interaction of a user, and may include a microphone 1131, a camera unit 1132, an optical receiver 1133, and a sensing unit 1134. The microphone 1131 may receive an audio signal including a voice uttered by the user or noise, convert the received audio signal into an electrical signal, and output the electrical signal to the processor 210.

The camera unit 1132 may include a sensor (not shown) and a lens (not shown), and may capture an image formed on a screen, and transmit the captured image to the processor 210.

The optical receiver 1133 may receive an optical signal (including a control signal). The optical receiver 1133 may receive an optical signal corresponding to a user input (e.g., a touch, a push, a touch gesture, a voice, or a motion) from a control device such as a remote controller or a mobile phone.

The sensing unit 1134 may detect a surrounding state of the electronic device and transmit the detected information to the communication unit 1120 or the processor 210. For example, sensors of the sensing unit 1134 may include, but are not limited to, at least one of a temperature/humidity sensor, an illumination sensor, a location sensor (e.g., a GPS sensor), a barometric sensor, and a proximity sensor.

The input/output unit 1140 may receive a video (e.g., a moving image signal or a still image signal), an audio (e.g., a voice signal or a music signal), and additional information from a device external to the electronic device 110 under control of the processor 210.

The input/output unit 1140 may include one of an High-Definition Multimedia Interface (HDMI) port 1141, a component jack 1142, a PC port 1143, and a Universal Serial Bus (USB) port 1144. The input/output unit 1140 may include a combination of the HDMI port 1141, the component jack 1142, the PC port 1143, and the USB port 1144.

The video processing unit 1150 may process image data to be displayed by the display unit 1160, and may perform various image processing operations, such as decoding, rendering, scaling, noise filtering, frame rate conversion, and resolution conversion, on the image data.

The display unit 1160 may output, on a screen, content received from a broadcasting station, an external server, or an external storage medium. The content is a media signal, and may include a video signal, an image, a text signal, and the like.

When the display unit 1160 is implemented as a touch screen, the display unit 1160 may be used as an input device, such as a user interface, in addition to being used as an output device. For example, the display unit 1160 may include at least one of a liquid-crystal display, a thin-film-transistor liquid-crystal display, an organic light-emitting diode, a flexible display, a three-dimensional (3D) display, or an electrophoretic display. In addition, two or more displays 1160 may be included according to their implementation type.

The audio processing unit 1170 processes audio data. The audio processing unit 1170 may perform various processing operations, such as decoding, amplification, or noise filtering, on the audio data.

The audio output unit 1180 may output an audio included in content received through the tuner 1110, an audio input through the communication unit 1120 or the input/output unit 1140, and an audio stored in the memory 220, under control of the processor 210. The audio output unit 1180 may include at least one of a speaker 1181, headphones 1182, or a Sony/Philips Digital Interface (S/PDIF) output port 1183.

In an embodiment, the audio output unit 1180 may reproduce and output music according to sheet music information generated by the processor 210.

The user input unit 1190 may receive a user input for controlling the electronic device 1100. The user input unit 1190 may include, but is not limited to, various types of user input devices including a touch panel for detecting a touch of the user, a button for receiving a push manipulation of the user, a wheel for receiving a rotation manipulation of the user, a keyboard, a dome switch, a microphone for voice recognition, a motion sensor for sensing a motion, and the like. When a remote controller or other mobile terminal controls the electronic device 1100, the user input unit 1190 may receive a control signal received from the mobile terminal.

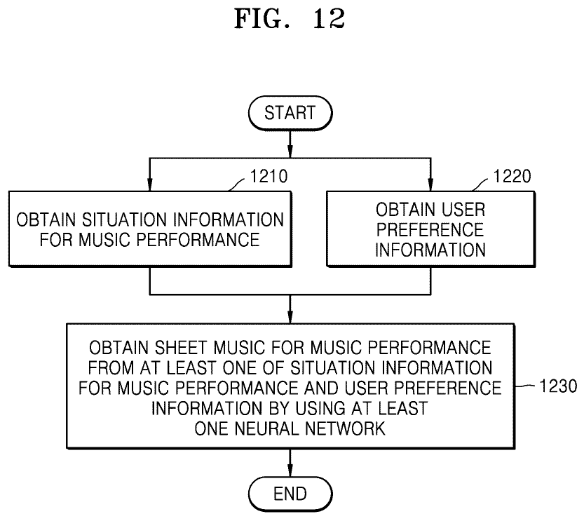

FIG. 12 is a flowchart of a process, performed by which an electronic device, of obtaining sheet music, according to an embodiment.

Referring to FIG. 12, an electronic device according to an embodiment may obtain situation information for music performance (operation 1210).

In an embodiment, the situation information for music performance may include at least one of user situation information, screen situation information, and external situation information. In an embodiment, the electronic device may obtain user situation information from an audio signal. In an embodiment, the electronic device may obtain screen situation information from an image output on a screen. In an embodiment, the electronic device may obtain external situation information through a sensor or a communication module.

In an embodiment, the electronic device may obtain user preference information (operation 1220).

The user preference information may refer to information indicating a user's hobby or preferred direction. In an embodiment, when the user's previous music listening history is available, the electronic device may obtain user preference information based on the previous music listening history. In an embodiment, the electronic device may obtain, from a user preference information database, user preference information based on information about music that the user has listened to.

In an embodiment, the user preference information may include at least one of identification information of the user, mood information of music that the user has listened to, velocity information, instrument information, information about a frequency of reproduction of music, information about a time during which music has been reproduced, information about a screen situation when music is reproduced, and information about an external situation when music is reproduced.

In an embodiment, the electronic device may obtain sheet music for music performance from at least one of the situation information for music performance and the user preference information by using at least one neural network (operation 1230).

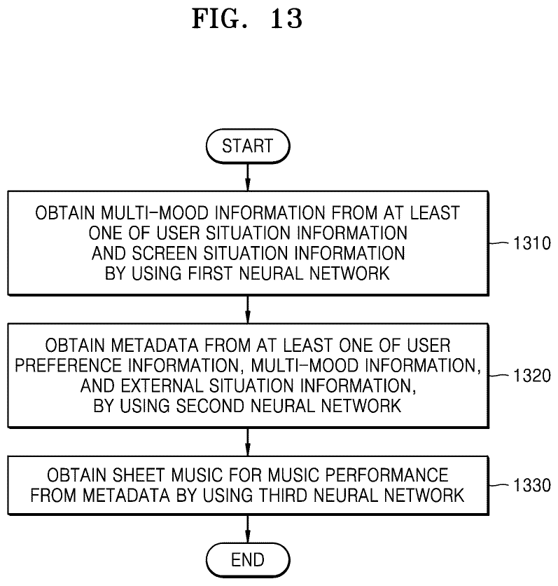

FIG. 13 is a flowchart of a process, performed by an electronic device, of obtaining sheet music by using at least one neural network, according to an embodiment.

Referring to FIG. 13, an electronic device according to an embodiment may obtain multi-mood information from at least one of user situation information and screen situation information by using a first neural network (operation 1310).

In an embodiment, the first neural network may be a neural network trained to have a weight that minimizes a difference between a ground-truth set and a weighted sum of a weight and a at least one variable of user situation information and screen situation information.

The electronic device according to an embodiment may obtain metadata from at least one of user preference information, the multi-mood information, and external situation information, by using a second neural network (operation 1320).

In an embodiment, the second neural network may include an encoder of a transformer model, and an output layer. For example, the second neural network may be implemented with a BERT model and an output layer.

The second neural network may obtain metadata including at least one of a tempo, a velocity, an instrument, and an ambient sound by embedding at least one of the user preference information, the multi-mood information, and the external situation information, inputting a result of the embedding into the encoder, and applying a softmax function to a weight output from the encoder, as an output layer.

In an embodiment, the second neural network may obtain metadata including at least one of a pitch and a music performance length by applying a fully connected layer to a weight output from the encoder, as an output layer.

The electronic device according to an embodiment may obtain sheet music for music performance from the metadata by using a third neural network (operation 1330).

In an embodiment, the third neural network may include a transformer-XL model. The third neural network may obtain a first probability distribution of an event sequence by embedding the metadata, and inputting a result of the embedding into the transformer-XL model, and obtain a first bar by sampling the first probability distribution of the event sequence.

In an embodiment, the third neural network may obtain a second probability distribution of the event sequence from the transformer-XL model by feeding forward the first bar to the transformer-XL model, and obtain a second bar subsequent to the first bar by sampling the second probability distribution of the event sequence.

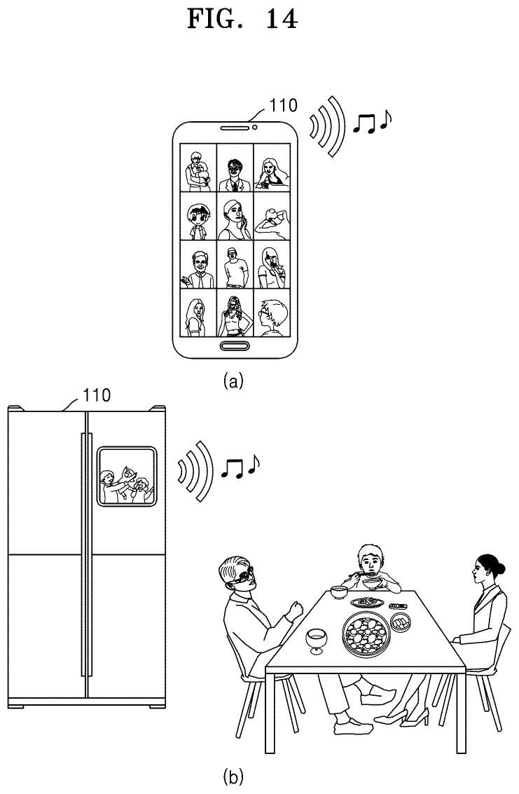

FIG. 14 is a diagram illustrating various situations in which an electronic device operates, according to an embodiment.

Referring to (a) of FIG. 14, the electronic device may be a mobile terminal such as a smart phone. The electronic device may group pictures that are similar to each other in style, color, type of object, or the like, from among a plurality of images stored in the electronic device, and output results of the grouping together on a screen. The electronic device may cluster pictures with similar styles in a user's picture folder or the like, automatically or in response to a control signal of the user. (a) of FIG. 14 illustrates, for example, a case where the images output on the screen are portraits of family members.

In an embodiment, the electronic device may obtain screen situation information from pictures of similar styles displayed on the screen. The electronic device may obtain at least one of style information and color information of the images.

In an embodiment, the electronic device may further obtain at least one of user situation information, external situation information, and user preference information.

In an embodiment, the electronic device may obtain multi-mood information using the obtained information. For example, the multi-mood information obtained by the electronic device may be information indicating various emotions such as happiness, warmth, and longing. In an embodiment, the electronic device may obtain metadata based on the multi-mood information. When there is other situation information in addition to the screen situation information, the electronic device may obtain metadata by considering the other situation information.

In an embodiment, the electronic device may generate sheet music by the using metadata, and cause music according to the sheet music to be reproduced on the electronic device. By using the electronic device, the user may view images of family members while listening to music that fits the images.

Referring to (b) of FIG. 14, the electronic device may be a display included on a front surface of a refrigerator. In an embodiment, the electronic device may output an image stored therein, or may receive and output an image stored in another electronic device of the user, such as a smart phone, a digital TV, or a laptop computer of the user, through a communication network. (b) of FIG. 14 illustrates, for example, a case where the image output on the screen is a family picture.

In an embodiment, the electronic device may obtain screen situation information by analyzing the image output on the screen.

In addition, the electronic device may obtain user situation information by receiving an audio signal. The electronic device may obtain user situation information about each of a plurality of users, or about the plurality of users together. The electronic device may identify the user from the user situation information, and obtain at least one of emotion information and activity information.

For example, the electronic device may obtain activity information indicating that users are having a conversation through audio signals. In addition, the electronic device may obtain emotion information indicating that the users are in a happy state, through sounds of laughter of the users or the tone or frequency of their voices.

The electronic device may obtain multi-mood information that fits the user's situation by considering the obtained user situation information and screen situation information together. For example, the electronic device may generate, as multi-mood information, information indicating various emotions such as joy, comfort, and cheerfulness. In an embodiment, the electronic device may obtain metadata in consideration of the multi-mood information, generate sheet music from the metadata, and cause music to be reproduced according to the sheet music. The user may use the electronic device to listen to music that fits the user's current situation or emotion.

An electronic device and an operation method thereof according to some embodiments of the present disclosure may be implemented as a recording medium including computer-executable instructions such as a computer-executable program module. A computer-readable medium may be any available medium which is accessible by a computer, and may include a volatile or non-volatile medium and a removable or non-removable medium. Also, the computer-readable medium may include a computer storage medium and a communication medium. The computer storage media include both volatile and non-volatile, removable and non-removable media implemented in any method or technique for storing information such as computer readable instructions, data structures, program modules or other data. The communication media typically include computer-readable instructions, data structures, program modules, other data of a modulated data signal, or other transmission mechanisms, and examples thereof include an arbitrary information transmission medium.

In addition, as used herein, terms such as “ . . . er (or)”, “ . . . unit”, “ . . . module”, etc., denote a unit that performs at least one function or operation, which may be implemented as hardware or software or a combination thereof.

In addition, an electronic device and an operation method thereof according to the above-described embodiments of the present disclosure may be implemented with a computer program product including a computer-readable recording medium having recorded thereon a program for implementing the operation method of the electronic device, and the operation method may include obtaining multi-mood information from at least one of the user situation information and the screen situation information by using a first neural network, obtaining metadata from at least one of the user preference information, the multi-mood information, and the external situation information, by using a second neural network, and obtaining the sheet music for music performance from the metadata by using a third neural network.

The machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

According to an embodiment, the method according to various embodiments disclosed herein may be included in a computer program product and provided. The computer program product may be traded as commodities between sellers and buyers. The computer program product may be distributed in the form of a machine-readable storage medium (e.g., a compact disc read-only memory (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

The above description is provided only for illustrative purposes, and those of skill in the art will understand that the present disclosure may be easily modified into other detailed configurations without modifying technical aspects and essential features of the present disclosure. Therefore, it should be understood that the above-described embodiments of the present disclosure are exemplary in all respects and are not limited. For example, the elements described as single entities may be distributed in implementation, and similarly, the elements described as distributed may be combined in implementation.

1. An electronic device comprising:
a memory to store one or more instructions; and
a processor configured to execute the one or more instructions that are stored in the memory to:
obtain situation information, for music performance, including at least one of user situation information associated with a user, screen situation information associated with a screen, and external situation information associated with at least one of the user and the electronic device,
obtain user preference information based on a previous music listening history of the user, and
obtain sheet music with representation useable for the music performance from at least one of the situation information obtained for the music performance and the user preference information of the user, by using at least one neural network.

2. The electronic device of claim 1, wherein the processor is further configured to:
obtain multi-mood information from at least one of the user situation information and the screen situation information, by using a first neural network,
obtain metadata from at least one of the user preference information, the multi-mood information, and the external situation information, by using a second neural network, and
obtain the sheet music for music performance from the metadata, by using a third neural network.

3. The electronic device of claim 2, wherein the first neural network comprises a softmax regression function, and
the first neural network is a neural network trained to have a weight that minimizes a difference between a ground-truth set and a weighted sum of a weight and at least one variable of the user situation information and the screen situation information.

4. The electronic device of claim 2, wherein the second neural network comprises an encoder of a transformer model and an output layer,
the metadata comprises first metadata including at least one of a tempo, a velocity, an instrument, and an ambient sound, and second metadata including at least one of a pitch and a music performance length,
the processor is further configured to:
embed at least one of the user preference information, the multi-mood information, and the external situation information,
input a result of the embedding into the encoder of the transformer model, obtain the first metadata by applying a softmax function as an output layer, to a weight that is output from the encoder of the transformer model, and
obtain the second metadata by applying a fully connected layer as the output layer, to the weight that is output from the encoder of the transformer model second metadata comprises at least one of a pitch and a music performance length.

5. The electronic device of claim 2, wherein the third neural network comprises a transformer-XL model, and
the processor is further configured to obtain a first probability distribution of an event sequence by embedding the metadata, and inputting a result of the embedding of the metadata into the transformer-XL model, and obtain a first bar by sampling the first probability distribution of the event sequence.

6. The electronic device of claim 5, wherein the processor is further configured to:
obtain a second probability distribution of an event sequence from the transformer-XL model by feeding forward the first bar to the transformer-XL model, and obtain a second bar subsequent to the first bar by sampling the second probability distribution of the event sequence.

7. The electronic device of claim 6, wherein the first probability distribution of the event sequence comprises a probability distribution for each of a tempo, a velocity, and a pitch.

8. The electronic device of claim 1, further comprising a user preference information database,
wherein the processor is further configured to:
obtain, from the user preference information database, user preference information obtained based on information about music that the user has previously listened to, reproduce music according to the sheet music for the music performance, and update the user preference information database by adding information related to the reproducing of the music, to the user preference information database.

9. The electronic device of claim 8, wherein the user preference information comprises at least one of identification information of the user, mood information, velocity information, ambient sound information, and instrument information of the music that the user has previously listened to, information about a frequency of reproduction of the music, information about a time during which the music has been reproduced, information about a screen situation when the music is reproduced, and information about an external situation when the music is reproduced.

10. The electronic device of claim 1, wherein the user situation information comprises at least one of user identification information, activity information, and emotion information, and
the processor is further configured to:
separate a voice and a noise from an audio signal, and obtain the user situation information from at least one of the voice and the noise by performing at least one of identifying the user based on the voice, obtaining emotion information of the user based on the voice of the identified user, and obtaining information about an activity performed by the user, based on at least one of the voice and the noise.

11. The electronic device of claim 1 further comprising a display,
wherein the processor is further configured to:
obtain the screen situation information based on at least one of style information and color information of an image that is output on the display.

12. The electronic device of claim 1, further comprising at least one of a sensor and a communication module,
wherein the processor is further configured to:
obtain the external situation information from at least one of weather information, date information, time information, season information, illuminance information, and location information that are obtained from at least one of the sensor and the communication module.

13. An operation method of an electronic device, the operation method comprising:
obtaining situation information for music performance including at least one of user situation information associated with a user, screen situation information associated with a screen, and external situation information associated with at least one of the user and the electronic device;
obtaining user preference information based on a previous listening history of the user; and
obtaining sheet music with representation useable for the music performance from at least one of the situation information for music performance and the user preference information, by using at least one neural network.

14. The operation method of claim 13, wherein the obtaining of the sheet music for the music performance comprises:
obtaining multi-mood information from at least one of the user situation information and the screen situation information by using a first neural network;
obtaining metadata from at least one of the user preference information, the multi-mood information, and the external situation information, by using a second neural network; and
obtaining the sheet music for music performance from the metadata by using a third neural network.

15. A non-transitory computer-readable recording medium having recorded thereon a program to implement an operation method of an electronic device, the operation method comprising:
obtaining situation information, for music performance, including at least one of user situation information associated with a user, screen situation information associated with a screen, and external situation information associated with at least one of the user and the electronic device;
obtaining user preference information based on a previous listening history of the user; and
obtaining sheet music with representation useable for the music performance from at least one of the situation information for music performance and the user preference information, by using at least one neural network.
